(19) United States
(12) Patent Application Publication
(10) Pub. No.: US 2012/0166741 A1
(43) Pub. Date: Jun. 28, 2012

(54) DATA BUS FOR LOW POWER TAG

(75) Inventor: John Birkbeck, New Milton (GB)

(73) Assignee: Roke Manor Research Limited, Romsey Hampshire (GB)

(21) Appl. No.: 13/266,996

(22) PCT Filed: Jan. 12, 2010
(86) PCT No.: PCT/GB10/50036

§ 371 Date: Mar. 20, 2012

(30) Foreign Application Priority Data
Apr. 28, 2009 (GB) 0907192.9

(51) Int. Cl. G06F 12/00; G06F 13/42; G06F 13/00

(52) U.S. Cl. 711/154; 710/305; 710/316; 711/E12.001

(57) ABSTRACT

A power supply and communication system comprising a single-wire data bus, itself having comprising a source end and a termination end, the termination end being connected to ground through a resistance of less than 10Ω. A circuit is connected at the termination end, between the single-wire data bus and ground, and the circuit comprises means for deriving its supply voltage and receiving input data from a time-variant signal applied to the single-wire data bus.

The present invention relates to a data bus for a low power tag which may be used with a near short-circuited termination. The data bus may be used to provide power from a source to a tagging circuit connected in parallel with the near-short circuit termination, to provide data for writing to a memory, and to read data from the memory.

The present invention provides a one-line bus, to which a circuit may be connected between the bus and ground, with no other electrical connections, and may be supplied with power, and have data read from, and written to, an associated memory. The circuit may be a data receiver, data transmitter or both.

The present invention will be particularly described with reference to a certain application, although the data bus of the present invention may find numerous other fields of application.

The invention may be applied to the storage and recall of data in electrically fired flares. Flares are well-known, and are typically a small pyrotechnic rocket used as a signal to alert others to a danger of some sort, or to provide illumination. Flares may be ignited by numerous arrangements, being lit by a flame, actuated by manual operation, or may be electrically fired, by some electronic control arrangement.

The application of the present invention relates to electrically fired flares.

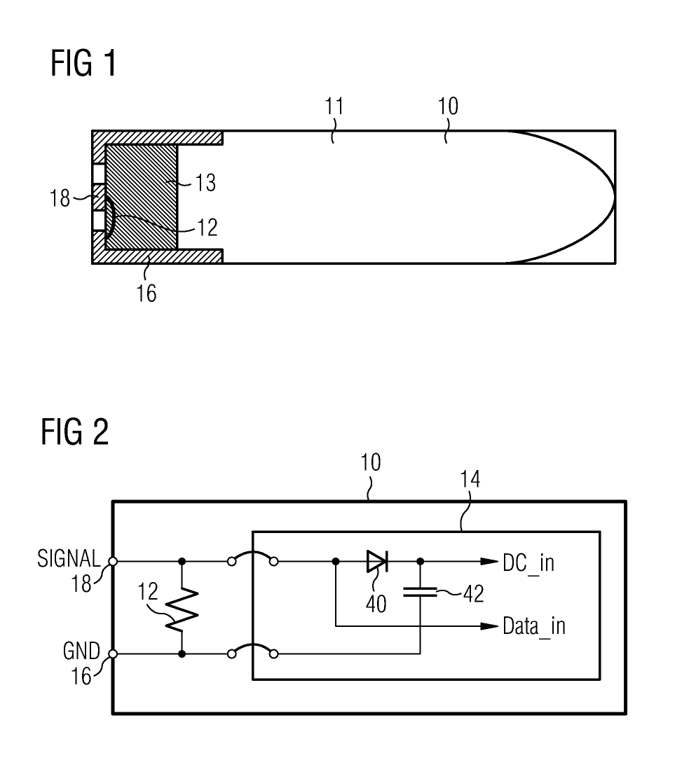

FIG. 1 schematically illustrates a conventional electrically fired flare 10. A fuse wire 12, having a low electrical resistance such as about 1Ω, is embedded within explosive compound 13 within the base of a firing cap 16. By applying a suitable electric current between signal terminal 18 and ground terminal 16, the fuse wire 12 heats up and ignites the explosive compound 14, causing the rocket 11 to fire.

Flares conventionally carry human-readable identification markings, such as colour codes and printed text on an external surface, to identify the type and intended use of the flare. However, the number of available types of flare has become so large that simple colour coding and text labels have become less effective. It is desired to provide an arrangement for electronic identification of flares.

It has become desired to provide tagging circuitry within the flare, and write data to a memory within the tagging circuitry, to store information such as number of hours in use, number of missions deployed etc. This data must also be readable. There is believed to be no current solution to this requirement.

In accordance with the present invention, there is provided methods and apparatus as defined in the appended claims.

The above, and further, objects, characteristics and advantages of the present invention will be described with reference to a limited number of embodiments, provided by way of non-limiting examples only, in which:

FIG. 1 schematically illustrates a conventional electrically fired flare;

FIG. 2 schematically illustrates an electrically fired flare modified according to an embodiment of the present invention;

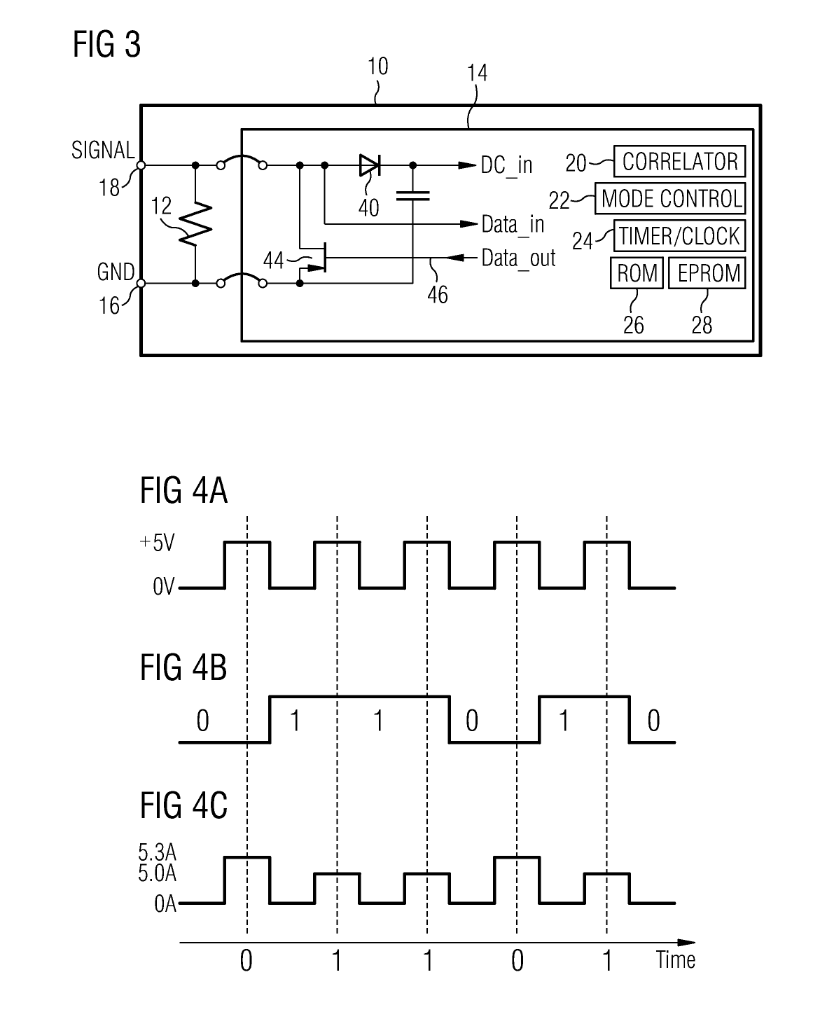

FIG. 3 schematically illustrates an electrically fired flare modified according to another embodiment of the present invention;

FIG. 4 illustrates waveforms used in reading stored data from the flare;

FIG. 5 schematically illustrates an electrically fired flare modified according to another embodiment of the present invention; and

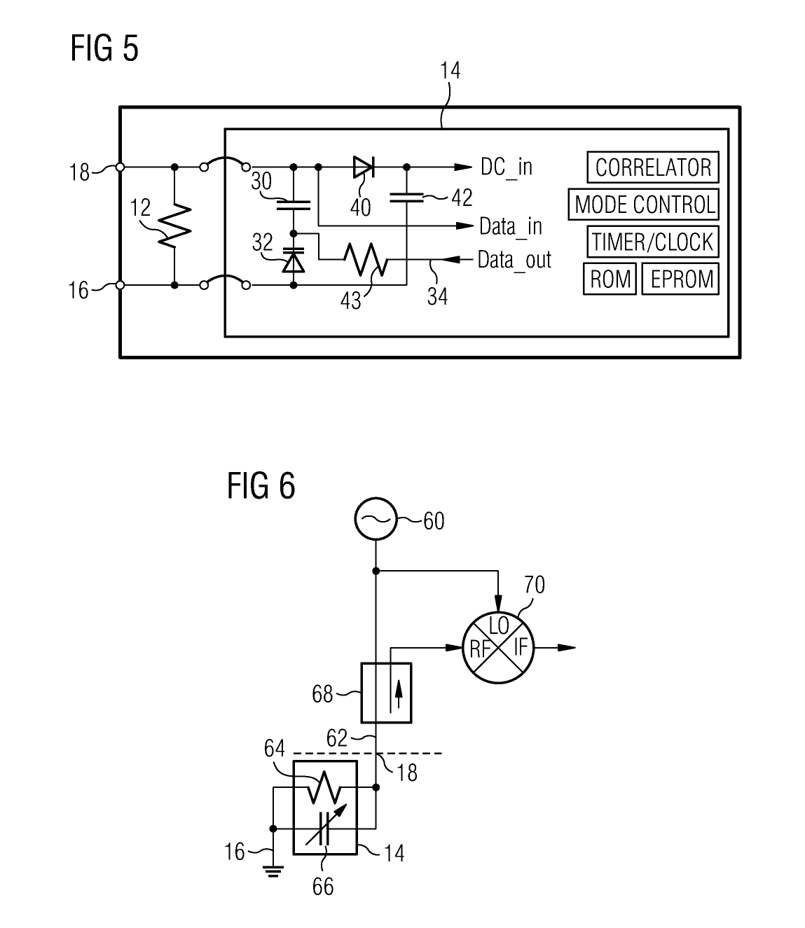

FIG. 6 schematically illustrates an example method for measuring a wave reflection coefficient.

As shown in FIG. 1, the conventional electrically fired flare has two electrical contacts: one being a ground terminal (GND) 16, and another (SIGNAL) 18, being a signal terminal, for receiving a firing signal in the form of an electric current. In order to maintain backwards compatibility of flares according to the present invention with conventional launchers and control circuits, the flares of the present invention must also operate with only two electrical contacts, one of which is grounded. The problem, then, is to provide a tagging circuit within the flare which can be powered, and includes a memory which may be read and optionally also written to over a single wire data bus which is connected to ground by a low resistance of less than 10Ω, more particularly a resistance of less than 2Ω, such as 1Ω. The read, write, and power functions must not detonate the flare.

FIG. 2 illustrates a flare modified according to a first embodiment of the present invention. In this embodiment, DC power supply circuitry and data supply circuitry are provided by an integrated circuit 14, having two external connections, is connected across the fuse wire 12 to the ground terminal 16 and the signal terminal 18. A CMOS integrated circuit is believed to be suitable, due to its low operating current requirements. However, the tagging circuit may be implemented as other types of integrated circuit, or in circuitry other than integrated circuitry.

The single wire data bus, connected to signal terminal 18, provides power from a remote source end to the termination end, and circuit 14, provided within the flare as illustrated.

A DC supply is required to operate the tagging circuit 14. It is preferred not to apply a DC voltage to the signal terminal 18, as this may detonate the flare. To prevent the fuse wire 12 from heating sufficiently to detonate the flare, it is preferred to apply a time-varying waveform. While this may simply consist of a series of DC pulses, consideration of side-effects such as electro-magnetic compatibility issues may mean that a more complex waveform should be applied. As an example, a series of sine waves may be applied.

In order to encode data onto the applied signal, the DC pulses, or sine waves, or other time-variant voltage, must be modified in some way to encode the data. With a time-varying signal, such as DC pulses, or sine waves, applied to the signal terminal, it is a trivial matter, well within the competencies of those skilled in the art, to encode data for transmission to the tagging circuitry into the time-varying signal. For example, the amplitude, duration, frequency, or separation of DC pulses may be varied to encode data. Similarly, the amplitude, or frequency of applied sine waves may be varied to encode data. The data encoded onto the time-varying signal arrives on the Data_in line, and may be detected by the tagging circuit in any suitable manner which will be apparent to those skilled in the art. The detected data may be interpreted, and the tagging circuit operated to store, and/or respond to, the applied data in a conventional manner which does not form part of the present invention. Received data may be written into a memory within the tagging circuit in a conventional manner.

None of these functions may be achieved, however, unless the tagging circuit 14 is powered. As illustrated in FIG. 2, a simple diode rectifier 40 and capacitor 42 may be used to derive a DC supply voltage DC_in from the applied time-varying signal. The diode 40 may not be necessary for deriving a DC supply voltage, but will prevent the smoothed DC voltage from interfering with the received data. This DC supply voltage DC_in is used to power the tagging circuit. Full-wave rectification may be used if the voltage applied to the signal terminal 18 makes negative excursions as compared with the ground terminal 16. The size of the capacitor 42, the duty cycle, frequency and voltage of the signal applied to the signal terminal 18 will determine the power available to power the tagging circuit 14.

With sufficient DC power derived from the signal applied to the signal terminal, the tagging circuitry 14 may be operated to store and retrieve data. The arrangement of FIG. 2 does not show arrangements for data read out from the tagging circuit. An object of the present invention is to provide methods and arrangements for reading data from the tagging circuit by a reader connected only by a single line bus. Practical integrated circuit capacitors will not have sufficient charge storage capacity to allow data to be presented directly on the signal terminal 18 in the conventional manner, as any output voltage would need to be provided across a very low resistance path to ground—the fuse wire 12—and the necessary current would discharge a capacitor in a short time. For example, a 1 nF capacitor typical of maximum sized capacitors included in integrated circuits would discharge in a few nanoseconds, insufficient time for the data to be read before the tagging circuit 14 loses power. A discrete capacitor could be provided, external to the integrated circuit and of higher capacitance. It is believed, however, that capacitors of reasonable size, weight and cost for the flare application for example, would still not provide sufficient power for conventional data presentation. It is also desired that minimum additional volume be added to the space occupied by the explosive compound, so the addition of large discrete capacitors is not preferred.

According to an aspect of the present invention, data output is provided by modulating a current provided externally through the signal terminal 18.

An example of data read-out circuitry is shown in FIG. 3. Certain functional elements of the tagging circuitry are schematically represented: correlator 20, mode control 22, timer/clock 24, ROM 26, EPROM 28. Not all of these features need be provided in any one embodiment, however.

Correlator 20 may be used to detect an arriving instruction. In response, the mode control circuit 22 may place the tagging circuitry in one of a number of different modes, such as reading/writing to/from different addresses of the EPROM. Timer/clock 24 may provide read/write synchronisation.

According to a feature of the present invention, data read-out from memory within the tagging circuit is performed by controlling a controlled component, for example a switching device 44 using a high input-impedance control terminal 46. In the illustrated embodiment, a field-effect transistor (FET) is used as the high input-impedance switching device 44. Preferably, a MOSFET (metal-oxide-semiconductor FET) is used, as these have very high input (gate) impedance.

The drain and source terminals of the FET act like a switch, and the electrical resistance between them will vary between open circuit, and a low resistance, for example about 20Ω, depending on the voltage applied to the gate terminal 46. In operation, the correlator 20 will detect that data read-out is required; the mode control circuit 22 will establish the corresponding mode of operation within the tagging circuit, the timer/clock will provide the required synchronisation, and the ROM 26 and EPROM 28 memories store data, and will provide the requested data onto the Data_out line connected to gate terminal 46.

A remote interrogator, which is reading data from the tagging circuit, will provide a current into, or draw a current from, the signal terminal 18. The impedance seen by the interrogator will either be the resistance of the fuse wire 12 alone, about 1Ω, or the resistance of the fuse wire 12 in parallel with the switching device 44, which has an impedance of about 20Ω in this example. This combination will have an impedance of about 0.95Ω. Sensitive detection circuitry will be able to determine whether the path between the signal terminal 18 and the ground terminal 16 within the flare has an impedance of 1Ω or 0.95Ω, and so detect a bit of data as represented by a voltage applied to the control gate 46 of the switching device 44.

Preferably, the interrogator applies the same time-variant voltage to the signal terminal 18 as is used for data writing, but as a clock signal, not modulated with data but having the same frequency and synchronisation as used for data input. The requested data are applied serially, bit-by-bit, to the control terminal 46 of the switching device 44. The current drawn by the flare at each cycle of the applied clock signal may be monitored, and cycles of higher current drain will indicate that the switch device 44 is conductive, while cycles of lower current drain will indicate that the switch device 44 is non-conductive. The applied clock signal will also provide power to keep the tagging circuit operational, allowing an indefinitely long data read sequence. By assigning a binary value ‘1’ to a conductive switch 44, and a binary value ‘0’ to a non-conductive switch 44, or vice-versa, read-out data may be communicated along the single wire bus to a remote reader.

FIG. 4 illustrates example signal waveforms during a data read sequence according to an example of this aspect of the present invention.

Waveform 4(a) illustrates a simple pulsed +5V DC clock waveform, applied to the signal terminal 18 to power the tagging circuit and enable data read out.

Waveform 4(b) illustrates output data supplied by the memory device(s) 26, 28 of the tagging circuit to the control terminal 46 of the switching device 44 as corresponding high and low voltage levels. Here, it is assumed that a high voltage level (also labelled ‘1’) causes the switch to be conductive, while a low voltage level (also labelled ‘0’) causes the switch to be non-conductive.

Waveform 4(c) shows the resultant current flowing through the signal terminal 18. The pulses of current are defined in time by the clock signal of waveform 4(a) applying +5V to the signal terminal. Current drawn by the tagging circuit will be 5.0 A if the switch 44 is open, and the impedance is defined by the fuse wire alone, or 5.3 A of the switch 44 is closed, and the impedance is defined by the parallel combination of the fuse wire 12 and the switch 44. By sampling the current at the remote reader, at times indicated by vertical dashed lines, and setting a threshold of, for example, 5.15 A, the read data may be detected, as illustrated at the foot of FIG. 4.

FIG. 5 illustrates an alternative embodiment of the present invention. In place of the FET switch of FIG. 3, a varactor 32 is used as the controlled component. The varactor is a semiconductor diode operated under reverse bias, so that it provides a variable capacitance which is controlled by a control input 34. The control input 34 is a DC level, and DC blocking capacitor 30 prevents the DC level from interfering with the data signal at signal terminal 18. By varying the capacitance of the varactor, an RF reflection coefficient, defined by the parallel combination of the resistance of the fuse wire 12 and the capacitance of the series combination of DC blocking capacitor 30 and varactor 32, will vary. The total capacitance seen externally by the bus is the series combination of the varactor and the bias block capacitor.

Similarly to the preceding embodiment, DC levels representing the read data will be applied to the control input 34. An RF signal is applied to the signal terminal 18, and will be reflected to a level determined by the reflection coefficient, itself determined by the capacitance of the varactor, indicating the polarity of a bit of output data. For example, pulses of an RF tone may be applied, of similar profile to the DC pulses discussed with reference to FIG. 4.

An example of a suitable data read circuit is a homodyne mixer driven from the applied RF signal and the resulting RF signal reflected back from the signal terminal 18. FIG. 6 shows an example of a circuit for detecting variation in RF reflection coefficients, and so for detecting the polarity of a data bit applied to control input 34 of the circuit of FIG. 5.

An RF signal source 60 emits an RF signal along the single wire data bus 62 to the signal terminal 18 of the tagging circuit 14. Tagging circuit 14 is schematically represented as a parallel resistor 64—capacitor 66 (RC) circuit, being a simplified equivalent circuit for the input characteristics seen by the RF signal source. Depending on the RF reflection coefficient, itself depending on the capacitance 66 of the varactor and DC blocking capacitor, a certain proportion of the applied RF signal will be reflected back along the single wire data bus towards the RF signal source 60. A directional coupler 68 samples the reflected RF signal. A homodyne mixer 70 is arranged to receive the applied RF signal on a local oscillator (LO) input, and the sampled reflected RF signal on the RF input. As the applied RF signal and the reflected RF signal will be of the same frequency, the output of the homodyne mixer will be a DC level on the intermediate frequency (IF) output. This DC level will change with changing RF reflection coefficient of the tagging circuit. By setting an appropriate threshold circuit, variations in the DC voltage produced at the IF output will represent output data from the tagging circuit.

The method of writing data to the arrangement of FIG. 5, and of providing power, is unchanged as compared to the arrangements of FIGS. 2 and 3. The DC power supply is derived by smoothing, including rectification if necessary, of data or RF read signals applied to the signal terminal 18.

The invention may be regarded as providing a controlled complex immitance as seen by a data read signal applied to the signal terminal 18 for data read-out. This is achieved by a controlled impedance device connected in parallel with the near-short-circuit termination of the single wire bus, the complex immitance being controlled in accordance with bits of serially read-out data.

“Immitance” is a term which covers both impedance and admittance. Using conventional symbols, complex impedance may be represented as Z=R+jX, while complex admittance may be represented as Y=G+jB. Complex admittance Y is the inverse of complex impedance Z, so Y=1/Z.

In the example embodiment of FIG. 4, the resistance R in the complex impedance Z=R+jX is varied, while in the embodiment of FIG. 5, the susceptance B in the complex admittance Y=G+jB is varied.

The presence of the communication and data storage circuitry described above does not interfere with correct operation of the flare. To activate the flare, a conventional DC or AC firing voltage is applied to the fuse wire 12, sufficient to ignite the flare. In such applications, it may be deemed unimportant whether the tagging circuit is damaged by the firing voltage. In other applications, where the tagging circuit is not destroyed, it may be necessary to provide protective circuitry to avoid damage by application of high or continuous DC or AC voltages to the signal terminal 18.

The present invention accordingly provides a single-wire bus which can provide power to a remote circuit 14, read data from it and write data to it, despite a near short-circuit bus termination 12. The present invention provides a facility for writing digital data to a flare, which was conventionally not provided for.

A machine interrogator can read data from the tagging circuit, typically representing the type, age and history of each flare, eliminating human error in these tasks.

An improved arrangement may be provided for a multi-flare dispensing system. Conventionally, each flare would have to be manually inspected and identified, recorded as to which dispenser location they are positioned in, and the corresponding firing control assigned. According to the present invention, all flares may be identified automatically and very rapidly, with electronic identification of the flares being provided.

The electronic identification system of the present invention allows many more classifications of flare to be recognised than could satisfactorily be identified by a conventional colour code or text imprinting read by a human operator.

As the bidirectional data bus of the present invention requires only one wire, which is also used for applying the firing current, flares modified according to the present invention are backwards-compatible with existing dispensers and firing controls. The same 2-pin connector may be used.

In addition to warning or emergency flares, the present invention may be applied to the control of large commercial firework displays. Once a complex display has been set up, a central controller may automatically check all devices to ensure that they are present and of the correct type.

The present invention may be applied to any type of single-wire system having a near short-circuit termination, such as incandescent and other light bulbs. In safety-critical lighting applications, the installation date (or other information) of a bulb may be stored in its internal memory, allowing the bulb to be identified and replaced near the end of its expected lifetime but before it has actually failed. Similarly, identification data may be stored inside the bulb's memory, such that a remote controller may ensure that the bulb is of the required type, origin and quality for its application.

While the above-described embodiments have discussed a single-wire bus with a low resistance termination, the present invention may be applied to a single wire data bus comprising any type of low-impedance line. For example, a data bus may be terminated with a large capacitance. In further alternatives, the low impedance may be provided by the impedance of the data bus itself. The capacitive impedance to ground, caused by a large capacitance between the data bus and ground, will prevent the signal line from being driven directly by the low power levels available to the tagging circuit 14.

1. A power supply and communication system comprising:
a single-wire data bus, itself having a source end and a termination end,
wherein the single-wire data bus is connected to ground through an impedance of less than 10Ω;
a circuit connected at the termination end, between the single-wire data bus and ground,
the circuit comprising means for deriving its supply voltage and receiving input data from a time-variant signal applied to the source end of the single-wire data bus.

2. A power supply and communication system according to claim 1 wherein the single-wire data bus is connected to ground through an impedance of less than 2Ω.

3. A power supply and communication system according to claim 1 wherein the circuit comprises a memory, and arrangements for writing data received from the single-wire data bus into the memory.

4. A power supply and communication system according to claim 1 wherein the circuit comprises a memory, and means for supplying data from the memory to the single-wire data bus.

5. A power supply and communication system according to claim 4, wherein the means for supplying data from the memory to the single-wire data bus comprises a controlled component connected between the single wire data bus and ground, the controlled component being controlled by a control terminal according to data supplied from the memory, such that the immitance between the single-wire data bus and ground is different when a data bit of a first polarity is applied to the control terminal from the immitance between the single-wire data bus and ground when a data bit of a second polarity, opposite to the first polarity, is applied to the control terminal.

6. A power supply and communication system according to claim 5, wherein the controlled component is a switching component having a relatively high resistance when a data bit of the first polarity is applied to the control terminal and a relatively low resistance when a data bit of the second polarity is applied to the control terminal.

7. A power supply and communication system according to claim 6, wherein the switching component is a field effect transistor (FET).

8. A power supply and communication system according to claim 5, wherein the controlled component has a relatively high reactance when a data bit of the first polarity is applied to the control terminal and a relatively low reactance when a data bit of the second polarity is applied to the control terminal.

9. A power supply and communication system according to claim 8 wherein the controlled component has a controlled capacitance.

10. A method of supplying power and data from a source along a single wire bus which is connected to ground by an impedance of less than 10Ω, to a circuit connected between the single wire of the data bus and ground, comprising the steps of:
applying a time-variant signal to the single-wire data bus at the source;
encoding data onto the time-variant signal at the source, and receiving it at the circuit;
smoothing the time-variant signal at the circuit to provide a DC supply voltage; and
detecting and responding to the encoded data at the circuit.

11. A method of supplying power and data from a source to a circuit according to claim 10 wherein the single-wire data bus is connected to ground through an impedance of less than 2Ω.

12. A method of supplying power and data from a source to a circuit according to claim 10, wherein the time-variant signal is cyclic, and is encoded with a single bit of data per cycle.

13. A method of reading data from a circuit along a single wire bus which is connected to ground by an impedance of less than 10Ω in parallel with the circuit, comprising the steps of:
applying a time-variant signal to the single-wire data bus at a source;
supplying power to the circuit by smoothing the time-variant signal at the circuit to provide a DC supply voltage;
at the circuit, using the time-variant signal as a clock signal to time serial data read-out;
applying the serial data to a control terminal of a controlled component connected between the single wire data bus and ground, the controlled component being controlled according to the applied serial data, such that the immitance between the single-wire data bus and ground is different when a data bit of a first polarity is applied to the control terminal from the immitance between the single-wire data bus and ground when a data bit of a second polarity is applied to the control terminal.

14. A method of reading data according to claim 13, wherein the controlled component is a switching component having a relatively high resistance when a data bit of the first polarity is applied to the control terminal and a relatively low resistance when a data bit of the second polarity is applied to the control terminal.

15. A method of reading data according to claim 13, wherein the controlled component has a relatively high reactance when a data bit of the first polarity is applied to the control terminal and a relatively low reactance when a data bit of the second polarity is applied to the control terminal.

16. A method of reading data according to claim 15, wherein the controlled component has a controlled capacitance.

17. A method of reading data according to claim 13 wherein the termination end of the single-wire data bus is connected to ground through an impedance of less than 2Ω.

18. A method of reading data according to claim 13 wherein the time-variant signal is cyclic, and is encoded with a single bit of read data per cycle, in accordance with the immitance of the controlled component.

19. A power supply and communication system comprising:
a single-wire data bus, itself having a source end and a termination end,
wherein the single wire is connected to ground through an impedance;
a circuit connected at the termination end, between the single-wire data bus and ground,
the circuit comprising means for deriving its supply voltage and receiving input data from a time-variant signal applied to the source end of the single-wire data bus,
the impedance being of a value too low for the circuit to supply output data onto the single wire data bus, while being powered exclusively by the supply voltage derived from the time-variant signal applied to the source end of the single-wire data bus,
wherein the circuit comprises a memory, and means for supplying data from the memory to the single-wire data bus, and
wherein the means for supplying data from the memory to the single-wire data bus comprises a controlled component connected between the single wire data bus and ground, the controlled component being controlled by a control terminal according to data supplied from the memory, such that the immitance between the single-wire data bus and ground is different when a data bit of a first polarity is applied to the control terminal from the immitance between the single-wire data bus and ground when a data bit of a second polarity, opposite to the first polarity, is applied to the control terminal.

20. A method of reading data from a circuit along a single wire bus which is connected to ground by an impedance in parallel with the circuit, comprising the steps of:
applying a time-variant signal to the single-wire data bus at a source;
supplying power to the circuit by smoothing the time-variant signal at the circuit to provide a DC supply voltage; and
at the circuit, using the time-variant signal as a clock signal to time serial data read-out;
applying the serial data to a control terminal of a controlled component connected between the single wire data bus and ground, the controlled component being controlled according to the applied serial data, such that the immitance between the single-wire data bus and ground is different when a data bit of a first polarity is applied to the control terminal from the immitance between the single-wire data bus and ground when a data bit of a second polarity is applied to the control terminal,
the impedance being of a value too low for the circuit to supply output data onto the single wire data bus, while being powered exclusively by the supply voltage derived from the time-variant signal.

21. An apparatus comprising a data tag having a memory and including a self-powered data circuit 1) configured to be coupled in parallel with a fuse across a single-wire bus, 2) configured to receive input data from a time-variant signal applied to the single-wire bus; and 3) configured for outputting a DC supply voltage by smoothing the time-variant signal.
